(19) United States
(12) Patent Application Publication
(10) Pub. No.: US 2026/0370367 A1
(43) Pub. Date: Nov. 19, 2026

(54) METHOD FOR COMPENSATING FOR A DELAY IN A DATA-TRANSMISSION NETWORK BASED ON THE TDMA PROTOCOL

(71) Applicant: SAFRAN, Paris (FR)

(72) Inventors: Patrick Thomas, Moissy Cramayel (FR); Aurélien Thomas Hernandez, Moissy Cramayel (FR); Raouia Ghodhbane Masmoudi, Moissy Cramayel (FR)

(73) Assignee: SAFRAN, Paris (FR)

(21) Appl. No.: 19/136,830

(22) PCT Filed: Dec. 1, 2023
(86) PCT No.: PCT/FR2023/051897

§ 371 Date: Jun. 6, 2025

(30) Foreign Application Priority Data
Dec. 9, 2022 (FR) FR2213130

(51) Int. Cl. H04J 3/06

(52) U.S. Cl. CPC H04J 3/0652

(57) ABSTRACT

The invention relates to a method for compensating for a delay in a bidirectional data-transmission network based on the TDMA protocol, between a master device and at least one slave device, said delay being due to electronic data-transmission means internal to the master and slave devices. The method comprising the following iterative steps: synchronising the slave device with master device by synchronisation on a synchronisation signal transmitted by the master device: —measuring the internal delay introduced by electronic data-transmission means for each master device; and —compensating for the measured internal delay.

### TECHNICAL FIELD

The present invention relates to data-transmission networks, and is more particularly directed to the time synchronisation of exchanges of such data according to the time division multiple access protocol.

### STATE OF PRIOR ART

Today, aeronautic and avionics systems utilise a very large number of sensors for different purposes. These sensors can be gathered into three main application categories:
regulation: these are the most critical sensors because data measured by these sensors are used to regulate the mechanical and hydraulic systems of aeronautic equipment in flight. They are used to servocontrol the system;
monitoring: data obtained by these sensors are used to monitor the behaviour and state of health of a system or structure of an aircraft in flight;
instrumentation: data measured by these sensors are used for ground and flight test benches in order to validate and carry out maintenance of aeronautic equipment. Benches are complex because they utilise a very large number of sensors.

Thus, each sensor used in an aircraft is independently connected by a cable to a calculator ensuring processing of its data. This is called point-by-point topology. Wiring associated with each of the sensors then becomes particularly imposing, which poses problems in terms of mass and overall size. As a result, the addition of new sensors is restrictive.

There are configurations that allow several sensors to communicate with a single calculator via a same cable, such as AFDX (Avionics Full-Duplex Switched Ethernet).

By way of example, as illustrated in FIG. 1, a distinction is made between two types of devices implemented to ensure communication of the sensors with the calculator, namely a device M1 configured as a “master” and devices configured as “slaves” E1, E2, ..., EN. A master or slave device is defined as a set of electronic components providing interfacing between the sensors and the calculator and jointly ensuring communication between the sensors and the calculator. “Slave” devices have the ability to interface with multiple sensors with different applications, and receive data measured by the same. The “master” device M1, which is connected to an aeronautical calculator, triggers data reception at each of the “slave” devices in order to transmit all the data collected to the aeronautical calculator. Thus, the “master” device manages communication over the sensor network.

Thus, the master device M1 transmits a setpoint TR3 in the form of a sequence of data to each “slave” node E1, E2, ..., EN.

In the context of bidirectional communication, each “slave” device E1, E2, ..., EN has programmable electronic means configured to transmit data TR2 to the “master” device M1, to indicate to it that the task has actually been carried out, for example.

The fact that a plurality of slave devices E1, E2, ..., EN exchange data via the same link with the master device MI requires the data to be multiplexed. A protocol used for this type of link is a so-called time-based multiplexing protocol, such as TDMA-Time Division Multiple Access protocol.

Thus, as illustrated in FIG. 2, the data sequences TR3, transmitted by the master device M1 to each slave device E1, E2, ..., EN, include data frames TR1 and TR2. In this example, each sequence TR3 has a duration in the order of 1 ms.

The master device M1 includes a master clock that clocks data emission in each of the sequences TR3. Similarly, each slave device X1, X2, ..., XN includes a slave clock that clocks data reception in each of the sequences TR3.

Each data frame TR1 comprises a master signal M, comprising data relating to the master device M1 such as sensor reading commands, or supervision and maintenance commands. Said frame TR1 also comprises an analogue synchronisation signal S.

Each data frame TR2 includes a plurality of time slots X1, X2, ..., XN for data transmission from each slave node E1, E2, ..., EN to the master device M1. In this example, there will be N=20 slave devices.

Each slave device E1, E2, ..., EN thereby has the possibility of communicating data TR2 with the master device M1 for a time slot allocated thereto and thus avoiding the risk of data interaction with the other slave devices.

To do this, it is necessary that the slave clock of each slave device E1, E2, ..., EN, for clocking data emission and reception, is perfectly synchronised with the master clock of the master device M1.

Stated differently, the slave clock of each slave device E1, E2, ..., EN has to be clocked on a same reference clock.

Patent FR 3,108,817 describes emission of an analogue synchronisation signal S in each data sequence TR1.

The synchronisation signal S comprises an amplitude adjustment portion S1, which is in the form of a sinusoidal wave having a constant amplitude during a predetermined number of pulses, and an optimised synchronisation portion S2, which is in the form of a triangular-shaped amplitude modulation for the sinusoidal wave. The optimised synchronisation portion S2 does not have a constant amplitude but a variable amplitude, thus transition between the increasing phase and the decreasing phase is quickly and accurately detectable, thereby determining a very accurate reference instant TOP. The master and slave clocks can thus be synchronised and time slots of each sequence TR3 can be very accurately time stamped. The reference instant TOP thus makes it possible to define the start of the period at which data X1, X2, ..., XN are respectively sent by each of the slave devices E1, E2, ..., EN to the master device M1.

However, emission and reception circuits of each device, whether master or slave, can lead, due to their electronic components, to the addition of a delay in propagating the synchronisation signal S or data TR2.

This delay also changes with the temperature at the master device and slave devices, which can become problematic in an environment with high thermal stresses.

This delay may also change depending on the transmission time due in particular to a long distance between the master device and the slave devices.

To compensate for these time lags, it is made use of very “advanced” signal processing techniques. Although highly effective, these techniques add complexity to the communicating system, either in terms of the computational power/electronic processing required, or because they increase the amount of information to be transmitted because data measured are mutually transmitted between devices or on a specific channel. By way of example, when the transmission line has a length of 30 metres, the delay generated is around 200 nanoseconds.

It is additionally possible to suppress this delay by frequency compensation, for example by using the compensation technique known as “Least squares (LS)” or “Minimum Mean Square Error (MMSE)”.

The challenge is therefore to overcome the problems previously mentioned.

### DISCLOSURE OF THE INVENTION

In view of the foregoing, the invention allows each of the master/slave nodes to synchronise independently.

To this end, the invention relates to a method for compensating for delay in a bidirectional data-transmission network based on the TDMA protocol, between a master device and at least one slave device, said delay being due to electronic data-transmission means internal to the master and slave devices, the method comprising the following iterative steps:
synchronising the slave device with the master device, by synchronising on a synchronisation signal emitted by the master device;
measuring the internal delay introduced by electronic data-transmission means for each master and slave device; and
compensating for the internal delay measured.

These steps are repeated in a loop.

Each node is thus able to perform measurement of its own electronics by “loopback”, without affecting other nodes on the electrical cable. Each node then uses this measurement to change the instant at which it will emit on the electrical cable and centre its reception signal listening window.

As such, each device autonomously measures the delay generated by the propagation of signals within its electronic transmission, i.e. data emission and reception, electronic circuit.

In other words, it is not necessary for a slave device to know the delay generated by the master device.

Similarly, when a master or slave device is in a communicating group, it is not essential that it acquires values of delays generated by other devices.

This frees up bandwidth and consequently increases the speed of data exchange between the master device and the slave device. Indeed, no learning frame is used for synchronisation between devices, thereby freeing up bandwidth.

Advantageously, during the step of synchronising the master device with the slave device, the slave device is synchronised on an analogue synchronisation signal emitted by the master device.

Furthermore, during the step of synchronising the slave device with the master device, a reference instant defining the start of a period for sending data to each slave device is extracted from data emitted by the master device.

According to a characteristic of the invention, the internal delay is measured by looping back a loopback signal between the output and the input of each master and slave device and by measuring the duration of propagation of the signal looped back between the output and the input of each master and slave device.

Advantageously, the loopback signal is generated at regular time slots.

Data are transmitted in the form of data sequences. For each data sequence, the reception is delayed by a duration substantially equal to a first delay value relative to the master device, and data transmission is advanced by a duration substantially equal to a second delay value relative to the slave device.

Another object of the invention is a bidirectional data-transmission system comprising a master device and at least one slave device, said system being capable of implementing bidirectional data communication between the master device and the slave device, the master device and the slave device comprising electronic data-transmission means according to a time division multiple access protocol, the data-transmission system comprising means for synchronising the slave device with the master device, by synchronising on a synchronisation signal emitted by the master device, means for measuring the internal delay introduced by the electronic data-transmission means for each master and slave device, and means for compensating the internal delay measured.

According to another characteristic of the transmission system according to the invention, the means for measuring the internal delay comprise means for looping back a signal between the output and the input of each master and slave device and means for measuring the duration of propagation of the signal looped back between the output and the input of each master and slave device.

Another object of the invention is a turbomachine comprising at least one system as defined above.

Further one object thereof is a sensor for aeronautical application, in particular for regulation, monitoring and/or instrumentation comprising a system as defined above.

Still another object of the invention is an aircraft comprising a turbomachine as defined above.

Another object of the invention is an aircraft comprising at least one system capable of implementing bidirectional data communication as defined above.

### BRIEF DESCRIPTION OF THE DRAWINGS

Other purposes, characteristics and advantages of the invention will become apparent upon reading the following description, given merely as a non-limiting example, and made with reference to the appended drawings, wherein:

FIG. 1, which has already been mentioned, schematically sets forth a master device communicating with a set of slave devices;

FIG. 2, previously mentioned, schematically represents a data frame emitted from the master device to the slave device according to the invention;

FIG. 3 illustrates a data communication system comprising a master device and a slave device according to prior art;

FIG. 4a and

FIG. 4b illustrate means for measuring a delay by looping back between the means for emitting and acquiring data of the master device and the slave device, respectively, according to one embodiment of the invention;

FIG. 5a and

FIG. 5b illustrate the principle of delay compensation implemented by means of the method and the device according to the invention, and illustrate transmission of a data sequence respectively without delay compensation, and with delay compensation; and

FIG. 6 shows a flowchart of a compensation method according to mode of implementation of the invention.

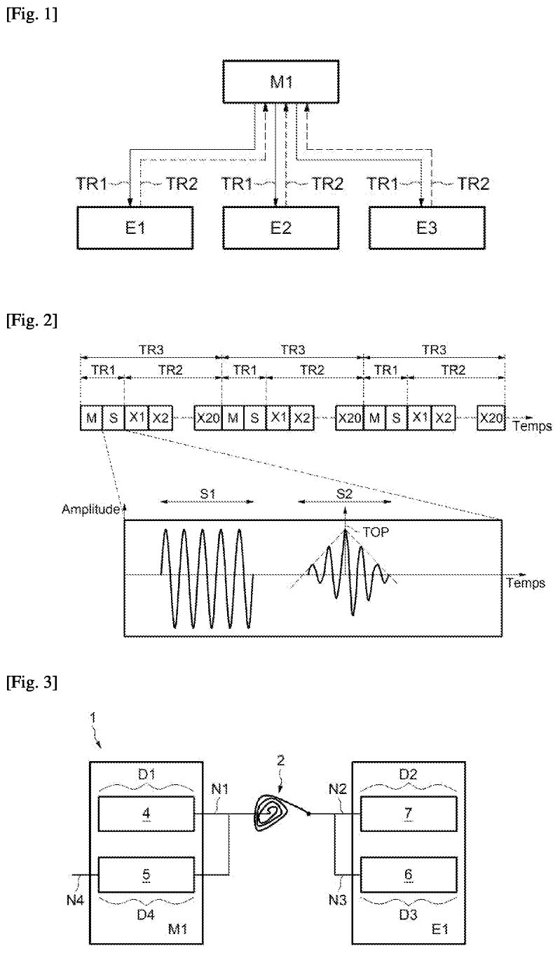

### DETAILED DISCLOSURE OF AT LEAST ONE EMBODIMENT OF THE INVENTION

In FIG. 3, an electronic system 1 which comprises the electronic master device M1 as well as the electronic slave device E1 is represented.

For the sake of clarity, the slave devices E2, ..., EN are not illustrated in said figure. Reference will then be made to a single slave device E1 but this does not exclude coupling of the master device M1 with a plurality of slave devices having an electronic architecture similar to the slave device E1.

In order to implement bidirectional data communication between the master device M1 and the slave device E1 according to the time division multiple access TDMA protocol, the electronic system 1 includes a transmission line 2 capable of propagating an analogue electrical signal.

The transmission line 2 is then coupled to emission means 4 and acquisition means 5 of the master device 1 on the one hand, and to transmission 6 and reception 7 means of the slave device E1 on the other hand.

More particularly, the emission means 4 include a chain of electronic components capable of transforming a digital signal into an analogue signal to then emit it to the slave device E1 via the transmission line 2.

As previously described with reference to FIG. 2, each data sequence TR3 comprises a header frame TR1 and a data frame TR2. The frame TR1 includes a master signal M, including data of the master device M1, emitted by the master device M1 for the slave devices E1, E2, ..., EN, an analogue synchronisation signal S, emitted by the master device M1 for the slave devices E1, E2, ..., EN. In particular, the signal S makes it possible to time stamp the time slots of the frames of the data sequence TR3 very accurately. Each frame TR2 also includes time slots X1-X20 for data transmission from each slave device to the master device M1.

The analogue synchronisation signal S comprises an amplitude adjustment portion S1 which is in the form of a sinusoidal wave having a constant amplitude during a predetermined number of pulses and a synchronisation portion optimised so as to determine a reference instant TOP according to patent FR 3,108,817. The reference instant TOP allows defining the start of the period at which data X1, X2, ..., XN are sent respectively by each of the slave devices to the master device. This reference instant TOP is known highly accurately. In addition, it allows accurately determining the time period between two reference instants TOP, which is in the order of 1 ms, in order to deduce the frequency of the master clock and possibly correct the frequency of the slave clock.

As such, the reception means 7 comprise a chain of electronic components for filtering the analogue signal TR3 received by the emission means 4 and to transform it into a digital signal to be processed.

As for the transmission means 6 of the slave device E1, their function is to emit an analogue signal to the acquisition means 5 able to filter it and then transform it into a digital signal. The analogue signal is ideally emitted by the transmission means 6 during the time slot allocated to the slave device E1 and comprises data TR2 which are transmitted to the master device.

However, the electronic components of the emission 4 and acquisition 5 means of the master device M1 as well as those of the transmission 6 and reception 7 means of the slave device E1 are likely to add a delay in propagating the synchronisation signal S or data TR1 and TR2.

This delay also changes as a function of the temperature at the master device M1 and the slave device E1 and/or as a function of the transmission time especially due to a long link distance between the master device and the slave devices.

Thus, at a first observation point N1 disposed between the transmission line 2 and the emission means 4, the propagation delay D1 of the analogue signal TR1 emitted to the slave device E1 is observed.

At a second observation point N2 located between the transmission line 2 and the reception means 7, the delay remains substantially equal to D1 because the delay related to the propagation of the signal through the transmission line 2 remains negligible.

By way of example, when the transmission line 2 has a length of 30 meters, the delay generated is in the order of 200 nanoseconds at most.

It is also possible to suppress this delay by MMSE (“Minimum Mean Square Error”) frequency compensation, for example.

When the signal TR1 is received by the reception means 7 and transformed into a digital signal, a delay D2 is added.

Similarly, the transformation of the digital signal into an analogue signal TR2 capable of being transmitted by the transmission means 6, leads to the addition of a delay D3 measured at a third observation point N3.

Finally, the reception of the analogue signal TR2 and its transformation into a digital signal by the acquisition means 5 is likely to extend the delay by a duration D4 measured at a fourth observation point N4.

It is therefore important to compensate for the propagation delays D1, D2, D3 and D4 when implementing data communication between the master device M1 and the slave device E1 according to the TDMA protocol.

Knowing said delays D1, D2, D3 and D4 makes it possible to synchronise the transmission windows of the signal X1-... XN and the listening windows of the signal X1-. . . XN during such a data exchange.

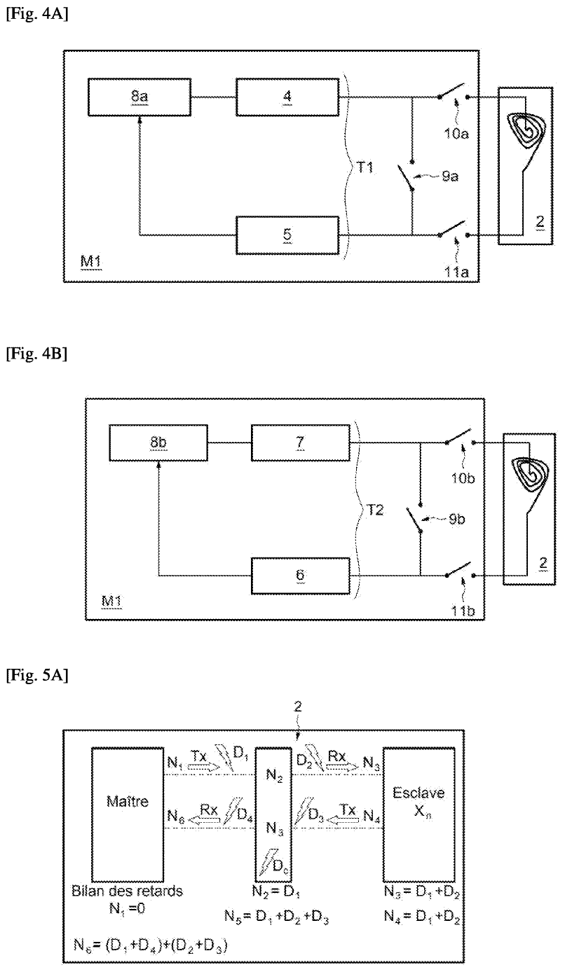

For this purpose, FIG. 4a illustrates the master device M1 which further includes measurement means 8a coupled to the emission means 4 and the acquisition means 5.

Such measurement means 8a are capable of generating an analogue loopback signal to propagate exclusively between the data-transmission 4 and acquisition 5 means and undergoing a propagation period due to the electronic transmission means of the master device.

To this end, the master device M1 includes a first switch 9a capable of coupling and decoupling the emission means 4 and the acquisition means 5.

The master device M1 further comprises a second switch 10a capable of coupling and decoupling the emission means 4 and the transmission line 2.

A third switch 11a is also disposed between the acquisition means 5 and the transmission line 2 so as to couple and decouple the reception means 5 and the transmission line 2.

Thus, the measurement means 8a can close the first switch 9a and open the switches 10a and 1a1 to circulate the loopback signal only between the data emission 4 and acquisition 5 means.

The propagation period of the loopback signal therefore corresponds to a first delay value T1 substantially equal to the sum of the delays D1 and D4.

As for the slave device E1, with reference to FIG. 4b, it also includes an electronic architecture similar to that of the master device M1 and moreover includes, measurement means 8b coupled to the transmission means 6 and to the reception means 7, as well as switches 9b, 10b, and 11b, so as to generate a loopback signal to propagate exclusively between the receiving means 7 and the transmission means 6 and undergoing a propagation period due to the electronic transmission means of the slave device.

A second delay value T2 is thus measured and corresponds substantially to the sum of the delays D2 and D3.

Stated differently, each device M1, E1 autonomously measures the delay generated by data propagation within its transmission circuit and its data reception circuit.

As previously stated, a delay is introduced in each viewpoint. Delays are therefore accumulated and added up at each point, which causes a lag that becomes significant, especially at viewpoint N4. The listening window of the master device M1 of the signal X1, X2, ..., XN thus has to be centred on data in order to avoid these lags. It is thus possible to anticipate the delay of the electronics, via the circuit developed and previously described, and adapt data transmission because the delay induced, especially by the electronics, is known.

It is to be noted that the delay values T1 and T2 are periodically measured in order to update them depending on the change in temperature at the master device M1 and the slave device E1. Periodic means that the master and slave devices are available (i.e. they are not monopolised by sending data at that particular moment). This measurement is performed once per cycle, each cycle preferably having a duration of 1 ms.

The loopback signals are therefore generated during the guard slot between two successive data sequences TR3. By guard slot, it is meant a slot in which the master or slave devices are free, i.e. they are neither emitting nor receiving.

Reference is made to FIGS. 5a and 5b which represent the electronic system 1 in which the delays T1 and T2 have been measured before emitting a data sequence TR3, respectively before compensation and after compensation.

In these figures, the observation points N1 and N6 are observation points of the master device M1, the observation points N2 and N5 are observation points of the transmission line 2 and the observation points N3 and N4 are observation points of the slave device.

Similarly, in these figures:
The period D1 represents the delay of the emission chain (Tx) of the master device: Δt_{Tx_M}=D1;
The period D2 represents the delay of the reception chain (Rx) of the slave device: Δt_{Tx_Xn}=D2;
The period D3 represents the delay of the emission reception chain (Tx) of the slave device: Δt_{Rx_Xn}=D3;
The period D4 represents the delay of the reception chain (Rx) of the master device: Δt_{Rx_M}=D4.

It will also be noted that the channel delay Dc represents the propagation time between the master device and the slave device, which is shorter than the period due to the electronics compensated for by means of the delay compensation method according to the invention, and which will be compensated for by the channel compensation.

Thus, the delay due to the emission chain (Tx) of the master device and the reception chain (Rx) of the slave device is: D1+D2.

The delay due to the emission chain (Tx) of the slave device and the reception chain (Rx) of the device is: D3+D4.

With reference to FIG. 5a, in the absence of compensation, the balance of delays at observation nodes N1 to N6 is written as:
N1=0
N2=D1
N3=D1+D2
N4=D1+D2
N5=D1+D2+D3
N6=(D1+D4)+(D2+D3).

For the receiver of the slave device (node N3), the delay applies to both the synchronisation pulse TOP and the data so that the time window is aligned with the allocated interval, without time lag.

Thus, the synchronisation problem arises in particular in the return direction, i.e. when transmitting signals from the nodes to the master device.

Thus, with reference to FIG. 5b, the delay resulting from the slave device E1 is compensated for by a displacement of the time listening window of the slave device E1. As for the acquisition means 5 of the master device M1, they are able to begin receiving the data TR2 depending on the first delay value T1.

For this purpose, the acquisition means 5 are configured to delay activation of the time listening window of the master device M1 by a duration substantially equal to the first delay value T1 measured.

Thus, at the fourth observation point N4, the receiver of the slave node sends its signal in advance. The balance of delays is thus D1+D2−(D2+D3) i.e. D1−D3.

Similarly, the period from the emitter to the device N5 is compensated for in advance. At node N5, the balance of delays is D1−D3+D3, i.e. D1. Note that this delay is compensated for by another method (MMSE for example).

At node N6, the balance of delays, due to the compensation, is written as D1+D4, the latter delay being compensated for by the master device by delaying its listening window with its own period measured.

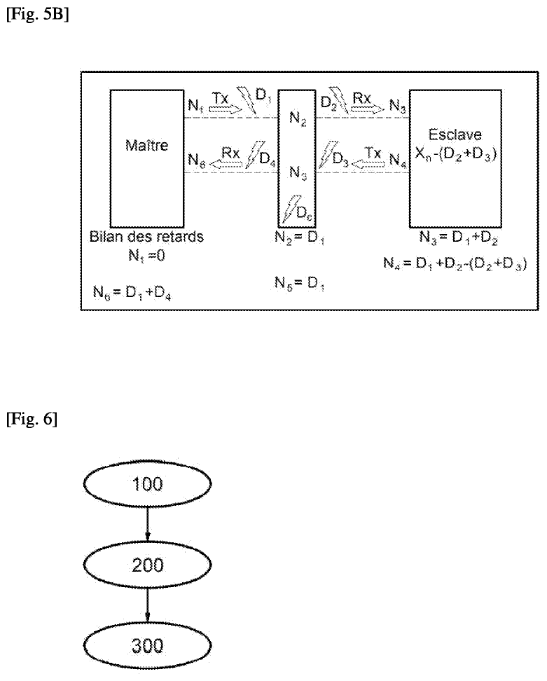

Reference is now made to FIG. 6 which illustrates a flowchart of a delay compensation method implemented during bidirectional data communication between the master device M1 and the slave device E1 implemented by the electronic system 1 according to the invention. It will be noted that the method steps are implemented iteratively and are permanently looped back.

The method begins with a step 100, during which the emission means 4 emit a data sequence TR3 to the slave device E1.

Since it is a data communication according to the TDMA protocol, the data sequence TR3 includes data frames TR1 and TR2. During this first step 100, the reference TOP is extracted from the synchronisation signal S, more particularly from the optimised synchronisation portion S2, emitted by the master device.

In step 200, the internal delay introduced by the electronics of each master and slave device is measured using the internal loopback system described previously.

The transmission means 7 of the slave advance transmission of data TR2 for a duration equal to the second delay value T2. When transmitting from the slave devices to the master device, the slave devices have to compensate for their delay time. Each slave device will emit earlier in its slot Xn and advance its transmission window by T2.

Finally, in step 300, the acquisition means 5 receive the data TR2 and delay their time listening window by a duration equal to the first delay value T1 known, as described previously with reference to FIGS. 5a, 5b.

When the period of the internal electronics is known, the system uses the measured period to compensate for delays in two stages:
Sending (transmitting) signals to the master device in advance;
Delaying the listening window of the signal in reception on the master device side

Thus, during step 300, the delays are compensated for using measurements obtained in step 200.

Thus, at each emission of a sequence TR3, the propagation delays T1 and T2 are compensated for.

Of course, the invention is not limited to the embodiments and implementations previously described and only provided by way of example.

In particular, the TDMA protocol may be combined with the method of coding digital signals by multi-subcarrier Orthogonal Frequency Division Multiplexing (OFDM). These techniques thus merged allow optimising usability of the spectrum. The total bandwidth is then divided into several subbands for a defined number of slave devices.

Alternatively, it is possible to perform single carrier modulation by PSK (“Phase-Shift Keying”).

1. A method for compensating for delay in a bidirectional data-transmission network based on the TDMA protocol, between a master device and at least one slave device, said delay being due to electronic data-transmission means internal to the master and slave devices, the method comprising the following iterative steps:
synchronising the slave device with the master device, by synchronising on a synchronisation signal emitted by the master device;
measuring the internal delay introduced by electronic data-transmission means for each master and slave device; and
compensating for the internal delay measured,
and wherein the internal delay is measured by looping back a loopback signal between the output and the input of each master and slave device, and measuring the duration of propagation of the signal looped back between the output and the input of each master and slave device.

2. The compensation method according to claim 1, wherein, during the step of synchronising the slave device with the master device, a time slot comprising a synchronisation signal comprising an amplitude adjustment portion and a synchronisation portion is extracted from the data emitted by the master device in the form of amplitude modulation capable of determining a reference instant (TOP defining the start of a period for sending data to each slave device).

3. The compensation method according to claim 1, wherein the loopback signal is generated at regular time slots.

4. The compensation method according to claim 1, wherein data are transmitted in the form of data sequences, and wherein, for each data sequence, the reception of data is delayed by a duration substantially equal to a first delay value relating to the master device, and the transmission of data is advanced by a duration substantially equal to a second delay value relating to the slave device.

5. A bidirectional data-transmission system comprising:
a master device; and
at least one slave device,
said system being capable of implementing bidirectional data communication between the master device and the slave device, the master device and the slave device comprising electronic data-transmission means according to a time division multiple access protocol, the data-transmission system comprising means for synchronising the slave device with the master device by synchronising on a synchronisation signal emitted by the master device, means for measuring the internal delay introduced by the electronic data-transmission means for each master and slave device, and means for compensating for the internal delay measured,
and wherein the means for measuring the internal delay comprise means for looping back a signal between the output and the input of each master and slave device and means for measuring the duration of propagation of the signal looped back between the output and the input of each master and slave device.

6. A turbomachine comprising at least one system according to claim 5.

7. A sensor for aeronautical application, in particular for regulation, monitoring and/or instrumentation comprising a bidirectional data-transmission system according to claim 5.

8. An aircraft comprising a bidirectional data-transmission system according to claim 5.
